(19) United States
(12) Patent Application Publication
(10) Pub. No.: US 2022/0154418 A1
(43) Pub. Date: May 19, 2022

(54) FOUNDATION FOR A TOWER STRUCTURE, TOWER FOR A WIND POWER INSTALLATION, AND WIND POWER INSTALLATION, AND ALSO METHOD FOR ESTABLISHING A FOUNDATION FOR A TOWER STRUCTURE

(71) Applicant: Wobben Properties GmbH, Aurich (DE)

(72) Inventor: Maria-Josefa BRAND, Aurich (DE)

(21) Appl. No.: 17/441,014

(22) PCT Filed: Mar. 13, 2020
(86) PCT No.: PCT/EP2020/056953

§ 371 Date: Sep. 20, 2021

(30) Foreign Application Priority Data
Mar. 21, 2019 (DE) 10 2019 107 266.2

(51) Int. Cl. E02D 27/42; F03D 13/20; E02D 5/30; E02D 27/02; E02D 27/16

(52) U.S. Cl. CPC E02D 27/425; F03D 13/22; E02D 5/30; E02D 2600/20; E02D 27/16; F05B 2240/912; E02D 2250/0023; E02D 27/02

(57) ABSTRACT

A foundation for a tower structure, in particular for a tower of a wind power installation, comprising a soil improvement unit with piles and with a slab which is arranged on the piles and which has a foundation side, wherein the foundation side forms a foundation plane, and a shallow foundation which has an areal standing side for mounting onto the foundation plane, wherein the shallow foundation is arranged on the slab.

### BACKGROUND

### Technical Field

The invention relates to a foundation for a tower structure, in particular to a foundation of a tower for a wind power installation. The invention furthermore relates to a method for constructing a foundation of a tower structure, in particular of a tower of a wind power installation. A tower structure may in particular be a tower of a wind power installation. The invention furthermore relates to a wind power installation having a foundation described herein.

### Description of the Related Art

Foundations constitute a structural and static configuration of a transition between a structure and soil and are generally configured to absorb all the loads of the structure which stands thereon and to dissipate said forces to the soil. Reliable dissipation of the loads allows prevention of undesired movements or deformations of the structures placed on the foundation.

Different types of foundations are known. When selecting the type of foundation, the soil on which a structure is to be erected is in particular of major importance. In order to be able to ensure stability of a structure to be erected over the long term, it is necessary that compressions of the soil that result from the loads of the structure which is formed preferably have no significant, in particular no adverse, effects on the structure. The foundation should therefore preferably be configured to receive, and to be able to dissipate into the substrate, static and dynamic loads, for example resulting from snow load and intrinsic load, wind pressure and/or water pressure and/or earth pressure and/or vibrations, in particular vertical and horizontal forces as well as moments. Furthermore, a pressure which is exerted from the foundation to the soil should preferably be taken into consideration, so as to limit subsidence that occurs to a non-hazardous level. Furthermore, it is necessary to determine the homogeneity of the soil in order, if appropriate, to be able to take into consideration inhomogeneities and, in this way, to be able to avoid differences in subsidence of different structure parts. It is moreover necessary to avoid, and/or to take into consideration, elevations and depressions associated with alternating frost and thaw. Prior to erecting a foundation, cavities situated below the earth's surface should moreover be secured against upward force due to groundwater, seepage water or floodwater.

Owing to the numerous requirements which are necessary for being able to reliably ensure long-term stability of the structure, foundations have to be adapted individually to the respective soil conditions and ambient conditions. The individual adaptation of a foundation requires a relatively high use of time and personnel. Laborious planning work is generally added to this. This often gives rise to high costs.

The German Patent and Trademark Office has searched the following prior art in the priority application relating to the present application: EP 2 799 622 A1.

### BRIEF SUMMARY

Provided are one or more techniques that provide reliable absorption of the loads acting on a tower structure and reliable dissipation of said loads to soil by means of an easily and/or cost-effectively producible foundation. These techniques further increase the reliability of the long-term stability of a tower structure being formed.

According to a first aspect, provided is a foundation for a tower structure, in particular for a tower of a wind power installation, comprising a soil improvement unit with piles and with a slab which is arranged on the piles and which has a foundation side, wherein the foundation side forms a foundation plane, and a shallow foundation which has an areal standing side for mounting onto the foundation plane, wherein the shallow foundation is arranged on the slab.

The preliminary work for production of a foundation comprises laborious and time-consuming work steps. In order to be able to ensure the stability of a structure over the long term, it is preferably possible for soil conditions to be determined prior to erecting a structure, in particular prior to producing the foundation. It can often be necessary to have a geological survey carried out that in particular assesses subsidence behavior and load-bearing capacity of the soil. Such preliminary work requires a relatively high use of time and personnel. Generally added to this is laborious planning work for selecting and individually adapting a suitable type of foundation with consideration taken of the structure to be erected, in particular of the loads to be expected, and also of the soil condition.

The known types of foundations include for example the deep foundation, the pile/slab foundation and the shallow foundation. Basically, owing to economy, for example, a shallow foundation may be preferred to the deep foundation. However, if there is no reliable information about the foundation conditions, in particular the soil, or if soil layers capable of bearing load are situated only at relatively great depths, the foundation of the structure may preferably be formed by a deep foundation. As an alternative to a deep foundation, a soil exchange may also be realized. This assumes, however, that the soil layers capable of bearing load are formed at easily reachable depths. In the case of a pile/slab foundation, a load-bearing system can be subdivided over piles, a foundation slab and soil. In the case of the pile/slab foundation, the structure loads can be dissipated both via the foundation slab and via the piles. What is required, therefore, are complex geotechnical calculations with consideration taken of the structure loads to be expected with regard to the pile arrangements, the pile dimensions, the slab dimensions, in particular the slab thicknesses, and the stiffnesses of the piles and the foundation slabs.

As described herein, there will be provided a foundation for a tower structure that comprises a soil improvement unit and comprises a shallow foundation. Thus, firstly, there is realized a soil improvement measure for preparing soil which is not suitable for a shallow foundation in such a way that, for the structure to be erected, a shallow foundation can in fact be used.

In this case, the soil improvement unit comprises piles which are introduced into the soil. Arranged on said piles, in particular on their upper ends, is a slab which has a foundation side. Said foundation side forms a foundation plane on which the shallow foundation is arranged. For this purpose, the shallow foundation has an areal standing side. The areal standing side may preferably be formed by a substantially planar bottom side of the shallow foundation.

Consequently, as described herein, it is possible for use to be made, irrespective of the soil condition, of a shallow foundation for constructing a foundation of a tower structure. In this case, the soil improvement unit forms the foundation plane, which is configured to receive loads aerially and to dissipate said loads into the soil via the piles. Owing to the design of the soil improvement unit with the slab arranged on the piles, preferably mounted on the piles, the advantages of a deep foundation can be combined with the advantages of a shallow foundation and disadvantages of a pile/slab foundation can be eliminated. In particular, no laborious preliminary work for determining a foundation adapted individually to the specific soil conditions is required. Rather, use may be made of a shallow foundation which has to be designed substantially according to the structure requirements, since, due to the soil improvement unit, a substrate suitable for a shallow foundation has already been created. The soil improvement unit, in turn, may be designed in such a way that it may be used for one or more structure categories (for example wind power installation towers of a certain size) and a number of soil conditions. This can lead to savings in terms of cost and time, since, in this way, use may be made, both for the soil improvement unit and for the shallow foundation, of constructions which are identical for a large number of applications.

The piles may preferably be formed as round and/or edged components which extend in a longitudinal direction and which can be introduced into soil and can be fixed in the soil. Here, the piles have a length which extends in the longitudinal direction and which is larger, in particular is a number of times larger, than a maximum diameter of a cross section vertical with respect to a longitudinal axis.

Where reference is made to piles, in particular to configurations of piles, this information relates preferably to at least two piles, in particular a multiplicity of piles, in particular a group of piles, in particular a plurality of piles, in particular all the piles. For example, it may be advantageous for at least two piles, in particular a multiplicity of piles, in particular a group of piles, in particular a plurality of piles, in particular all the piles, to be oriented substantially vertically and/or obliquely. It may furthermore be advantageous, for example, for all the piles to be produced identically or for differently produced piles to be used, wherein preferably at least two piles, in particular a multiplicity of piles, in particular a group of piles, in particular a plurality of piles, in particular all the piles, can be produced differently.

Owing to the piles, the soil improvement unit may also be used on soft and/or aqueous soil and/or at narrow construction sites. The introduction of the piles into the soil may preferably be realized by pile-driving and/or boring and/or jetting and/or pressure injection and/or vibrational driving and/or winding. Here, for example, a pile foundation-constructing process with soil displacement and/or displacement boring process and/or pile foundation-constructing process with earth excavation may be carried out.

A shallow foundation may preferably be understood as meaning a foundation lying flat, which is preferably arranged directly below the tower structure, in particular below the lowermost structure part, preferably the lowermost tower segment, and is configured to transmit a load areally to the soil improvement unit. In this case, the shallow foundation may preferably be in the form of a shallow foundation without upward force.

It is in particular preferable for the shallow foundation to be configured for being introduced into the soil with a maximum introduction depth of approximately 80 to 150 cm. Preferably, a shallow foundation may be introduced at most 50% or 40% or 30% or 20% of a total height into the soil. Alternatively, the standing side of the shallow foundation may be aligned with a ground top edge.

The shallow foundation may preferably be in the form of a single foundation and/or strip foundation and/or strip grillage foundation and/or slab foundation.

The shallow foundation may preferably be configured for arrangement thereon of a lower structure part of the structure to be erected, in particular a lower tower segment of a tower structure. The lower structure part may preferably form a wall of the structure to be erected and in particular have a door. Furthermore, a lower structure part may preferably be configured for arrangement on a foundation and in particular for connection to at least one further structure part. Preferably, the lowermost structure part may bear the structure, in particular the further structure parts. It is furthermore preferable for the lowermost structure part to be able to be prestressed together with further structure parts, in particular all the structure parts. The lowermost structure part may preferably form a part of a substantially cylindrical or conical tower. By contrast to this, the shallow foundation is not a constituent part of the structure, in particular of the tower structure, and also does not form a part of a casing surface of the structure. The shallow foundation is designed as a load-dissipating unit between the soil improvement unit and the lowermost structure part. Here, the shallow foundation may preferably be designed according to the structure to be erected and the structure loads to be expected.

A top side of the slab is formed as the foundation side. The foundation side in this case forms the foundation plane, which is preferably configured to be areal, in the sense of level, that is to say substantially planar and without relatively large elevations and depressions, in particular horizontal in a state of installation. The bottom side of the shallow foundation, which bottom side is preferably formed as an areal standing side, is arranged on said foundation side. The standing side may preferably also be configured to be areal, in the sense of level, that is to say substantially planar and without relatively large elevations and depressions.

By contrast to a pile/slab foundation, in which the structure is erected directly on the slab arranged on the piles, as described herein, there is provided a soil improvement unit with piles and a slab which is arranged on the piles and on which the actual foundation of the structure, that is to say the shallow foundation, is arranged or erected. The structure itself may then preferably be erected on the shallow foundation. The shallow foundation may preferably be configured to absorb structure loads and to direct said loads into the substrate via the soil improvement unit. The shallow foundation may preferably ensure overall stability and avoid base failure. Due to the arrangement of the shallow foundation on the soil improvement unit, it is preferably not or only conditionally necessary to take into consideration limit states relating to the soil, such as for example excessive subsidence, excessive elevation due to swelling, frost or other causes and the like, since said limit states relating to the soil can preferably be avoided or at least limited by way of the soil improvement unit.

With a shallow foundation, it is preferably the case that structure loads can be dissipated areally to the slab of the soil improvement unit. Here, the shallow foundation may preferably be configured to be able to absorb bending forces and, in this way, to be able to distribute the structure load. Said bending forces preferably no longer occur at the soil improvement unit.

The shallow foundation can preferably be held in position on the slab by means of an abutment connection and/or a contact connection. Owing to the inherent weight of the shallow foundation, there may preferably be no need for any further connection between the slab and the shallow foundation. In this way, the production and the erection of the foundation can be simplified. In particular, it may be preferable for the shallow foundation, in particular the standing side thereof, and/or the soil improvement unit, in particular the foundation side of the slab, to be formed from concrete or to comprise concrete. The concrete-on-concrete contact surface formed in this way has a coefficient of friction which is advantageous for stability.

Due to the two-part construction of the foundation, a load which has been absorbed by the shallow foundation can be introduced into the slab of the soil improvement unit and can be dissipated into relatively deep soil layers via the piles.

Such a foundation is advantageous to the extent that a shallow foundation can be used irrespective of the actual soil conditions to be able to absorb all the loads of the structure formed and to be able to dissipate said loads to the soil. This configuration makes it possible to increase the reliability of the long-term stability of a tower structure to be erected and at the same time the cost-effectiveness of the foundation.

Due to the subdivision of the foundation into a soil improvement unit and a shallow foundation, it is preferably possible for the erection of the foundation to be spread out over time. In this regard, it is possible for example firstly for the soil improvement unit to be erected and subsequently, possibly with a large time interval too, such as for example after a winter, for the shallow foundation to be erected.

A further advantage of such a foundation may be seen in the fact that the soil improvement unit may preferably be produced serially and used for different shallow foundations, in particular with regard to the dimensions.

Overall, such a foundation with a soil improvement unit and with a shallow foundation can be produced significantly more cost-effectively and/or more quickly and/or more easily than known solutions for a foundation. Consequently, the outlay in terms of personnel and/or time can be reduced and/or costs can be saved. Furthermore, foundations produced in this way also make it possible for tower structures to be produced more cost-effectively and/or more quickly and/or more easily overall. In particular, laborious preliminary work for planning the foundation can be reduced significantly.

Foundations, in particular slabs and/or shallow foundations, may preferably have, orthogonally to a vertical axis, a generally ring-shaped or a round, preferably a circular, and/or a polygonal, preferably a square and/or rectangular, cross section. In particular preferably, foundations, in particular slabs and/or shallow foundations, may be matched to the geometry of a tower structure, in particular a wind power installation tower. Tower structures may for example generally have a ring-shaped cross section orthogonally to the vertical longitudinal axis. Said ring-shaped cross section may be of circular ring-shaped form or else have a polygonal shape. Therefore, in the present case, the expression ring-shaped is to be understood as meaning not only a circular ring-shaped configuration but also a polygonal and/or multi-corner configuration with multiple straight sections.

Where reference is made herein to an arrangement and/or a direction of extent of the foundation and/or of the soil improvement unit, in particular the piles and/or the slab, and/or of the shallow foundation, this information relates to the state of installation of the foundation and/or of the soil improvement unit, in particular the piles and/or the slab, and/or of the shallow foundation. Preferably, information such as horizontal, vertical, bottom, top, etc., and descriptions such as bottom side, top side, etc., relate to the state of installation of the foundation and/or of the soil improvement unit, in particular the piles and/or the slab, and/or of the shallow foundation.

The state of installation may be understood as meaning the state in which the piles are introduced into the soil and are surrounded by the soil, the slab is arranged on the piles, in particular on the upper ends thereof, and the shallow foundation is arranged on the slab.

A soil may be understood as meaning a subsurface which comprises at least one soil layer, preferably soil layers, and which is configured for holding the soil improvement unit and thus also the shallow foundation. The soil may be processed prior to the erection of the foundation, in particular prior to the introduction of the piles into the soil. For example, soil may be excavated and/or levelling and/or compacting may be carried out. It is in particular preferably the case that a construction base defining a surface of the soil can be formed. Here, the construction base may preferably be formed below the ground top edge or be aligned with the ground top edge. Preferably, the construction base may preferably be of horizontal form.

The techniques described herein are not restricted to use with tower structures, in particular wind power installation towers, even though it can be used here particularly advantageously and in a cost-effective way. Rather, a foundation defined in the present case may also be used with structures of another type, in particular pile-type structures.

Preferably, the slab may have the foundation side and a connection side, wherein preferably the connection side is formed as a bottom side of the slab and opposite the foundation side. It is in particular preferable for the connection side to be able to be formed parallel to the foundation side and preferably horizontally. The connection side may preferably be configured to be arranged, preferably in the sense of formed, on the piles, and/or to be passed through by the piles. Preferably, the piles, in particular the upper ends thereof, which are also referred to as connection reinforcement, are formed in one piece with the slab. It is particularly preferred that in particular the upper ends of the piles are concreted together with the slab.

It is in particular preferable for the piles to be able to oriented substantially vertically. A vertical orientation may preferably be understood as meaning that the longitudinal axis of the piles and thus also the length of the piles extend in a vertical direction. The vertical direction may preferably be substantially orthogonal to the construction base and/or to the slab, in particular the connection side. In this case, it is in particular preferable for piles to be introduced into the soil substantially in the vertical direction. Furthermore, the piles may in particular be arranged parallel to one another and introduced into the soil.

Some or all of the piles may also be oriented obliquely. Oblique may preferably be understood as meaning that, in the state of installation, the piles have an inclination in relation to a vertical. Here, the piles may preferably have an inclination of at most 8:1 and/or 4:1.

In the state of installation, the slab may preferably be arranged horizontally. In particular, the slab may be oriented orthogonally to the piles, in particular with substantially vertically oriented piles. Preferably, the slab may be oriented in such a way that a horizontally oriented foundation plane is formed.

It is in particular preferably the case that the shallow foundation may have a maximum outer diameter of at least 12 m to at most 30 m. Preferably, the shallow foundation may have a minimum outer diameter of at least 12 m to at most 30 m. Preferably, the shallow foundation may have a maximum inner diameter of at least 2.2 m or of at least 5 m. Preferably, the shallow foundation may have a minimum inner diameter of at least 2.2 m or of at least 5 m. The maximum outer diameter and/or the minimum outer diameter and/or the maximum inner diameter and/or the minimum inner diameter may be selected preferably in a manner dependent on the tower structure to be erected. For example, in the case of a steel tower, the inner diameter may be at least 2.2 m. Furthermore, for example in the case of a concrete tower or hybrid tower, a maximum inner diameter of at least 5 m may be selected.

Preferably, a soil improvement unit may comprise differently produced piles. In particular, a soil improvement unit may comprise piles which are produced identically. The piles may preferably consist of different materials, or be produced in different ways, according to purpose of use, soil conditions and ambient conditions. During production, a distinction between prefabricated piles, cast-in-place concrete piles and composite piles is preferably possible.

Prefabricated piles may preferably be prefabricated over the entire length or in parts and installed. Cast-in-place concrete piles may preferably be concreted in the borehole. In the case of composite piles, it is preferable possible for a prefabricated bearing member, in particular steel or concrete, to be introduced into a borehole and, there, to be injected with cement mortar. In this case, a connection of the soil and the bearing member can preferably be formed. For example, use may also be made of an injection anchor, which is produced as an injection pile and injection anchor with prestress.

It is particularly preferably possible for the piles, preferably two piles and/or a multiplicity of and/or a plurality of and/or all the piles to be in the form of precast piles and/or cast-in-place concrete piles and/or bored piles and/or micropiles and/or prestressed piles.

The piles may preferably be in the form of precast piles, which in particular have width/thickness dimensions of 40 cm/40 cm to 60 cm/60 cm, preferably 45 cm/45 cm or 50 cm/50 cm. The precast piles may preferably be formed from concrete or comprise concrete. It is particularly preferably possible for the precast piles to be in the form of driven piles.

Furthermore, the piles may be in the form of cast-in-place concrete piles, which preferably have a diameter of at least 46 cm to at most 56 cm, preferably a diameter of 46 cm or 51 cm or 56 cm.

Furthermore, the piles may be in the form of bored piles, which preferably have a diameter of at least 60 cm to at most 120 cm, preferably a diameter of 60 cm or 80 cm or 100 cm or 120 cm.

The piles may in particular be in the form of micropiles, preferably small diameter injection piles. Micropiles may preferably have a diameter of less than 30 cm. Micropiles may preferably be distinguished in that their load can preferably be dissipated into the surrounding soil via casing friction. In order to be able to achieve an inner load-bearing capacity, it is preferably possible for a steel bearing member, which is in particular arranged centrally, to be installed in the interior of a micropile.

It is furthermore preferably possible for use to be made of prestressed piles which are able to comprise a prestressing steel.

Preferably, the type of the piles and/or the dimensions, in particular the length and/or the diameter, of the piles may be selected in a manner dependent on the soil condition and/or the ambient conditions and/or loads occurring. A number of piles and/or an arrangement, in particular a distribution, of the piles may also be selected in a manner dependent on the soil condition and/or the ambient conditions and/or loads occurring and/or, in particular, the type of the piles.

In particular, it is also possible for a number of required piles to be reduced if, for example, the dimensions, preferably the diameter, of the piles are/is increased. Conversely, it is also possible for a number of required piles to be increased if, for example, the dimensions, preferably the diameter, of the piles are/is reduced. This configuration allows the soil improvement unit and in particular also a method for introducing the piles of the soil improvement unit to be matched to the soil conditions and the ambient conditions.

In a particularly preferred embodiment variant of the foundation, it is provided that the shallow foundation has a maximum extent in a width direction that is greater than a maximum extent in a height direction. The maximum extent in the width direction may preferably be a maximum diameter of the shallow foundation. The maximum extent in the height direction extends substantially from the bottom side of the shallow foundation, which bottom side is formed as a standing side, to a top side of the shallow foundation. For determining the maximum extent in the height direction, a maximum distance between the top side and the bottom side of the shallow foundation may accordingly be measured. A maximum height of the shallow foundation may preferably be between 40 cm and 400 cm, preferably between 80 cm and 250 cm.

Preferably, the extent in the width direction of the shallow foundation and/or the maximum outer diameter and/or the maximum inner diameter of the shallow foundation may be selected in a manner dependent on the dimensions of the structure to be erected on the shallow foundation. Here, it is particularly preferable for the maximum outer diameter of the shallow foundation to be at least as large as, preferably larger than, a maximum diameter of the structure to be erected.

In particular, it is preferable for the shallow foundation to have dimensions for arrangement completely or partially below the ground top edge. Preferably, at least a part of the shallow foundation that is situated above the ground top edge can be concealed completely or partially by a soil deposit. In this way, the shallow foundation can be incorporated into the soil deposit and additionally stabilized.

Preferably, the slab may have a maximum diameter of at least 13 m and/or of at most 31 m.

According to a further preferred embodiment variant, it is provided that the slab has a maximum diameter of at least 13 m to at most 31 m. This configuration allows the soil improvement unit to be combined with different shallow foundations and therefore preferably produced serially. The maximum diameter may preferably be selected in a manner dependent on the shallow foundation to be erected. Here, it is advantageous for the maximum diameter of the slab to be larger than the maximum diameter of the shallow foundation or for the maximum diameter of the slab to correspond to the maximum diameter of the shallow foundation.

Particularly preferably, the slab may have a maximum thickness of at least 40 cm to at most 80 cm. This maximum thickness makes it possible for the soil improvement unit and thus the slab to be arranged substantially below a ground top edge without a relatively large soil excavation. The foundation side of the slab may preferably be situated below the ground top edge or be aligned with the ground top edge.

Preferably, the slab may have a maximum diameter of at least 13 m to at most 31 m and/or a maximum thickness of at least 40 cm to at most 80 cm.

A further preferred development of the foundation is distinguished in that the slab comprises reinforced concrete. Preferably, the slab may be formed from reinforced concrete. It is preferable for the piles to comprise reinforced concrete. Preferably, the piles may be formed from reinforced concrete. It is furthermore preferable for the shallow foundation to comprise reinforced concrete. Preferably, the shallow foundation may be formed from reinforced concrete. In particular, it is preferable for the slab and/or the piles and/or the shallow foundation to comprise reinforced concrete, in particular to be formed from reinforced concrete. The slab and/or the piles and/or the shallow foundation may consequently comprise concrete and reinforcement, in particular reinforcement steel. In this way, it is possible to achieve both high compressive strength and high tensile strength.

Reinforcement may generally be understood as meaning a three-dimensional strut construction. The reinforcement basically serves for strengthening, in particular the load-bearing behavior, in conjunction with concrete or another composite material of the reinforced element. The reinforcement allows both compressive forces and tensile and bending forces to be absorbed. The reinforcement may preferably comprise rods or fibers of materials of high tensile strength, such as for example metal, in particular steel, glass and/or carbon.

In particular, it is preferable for the slab to be connected to the piles. In this case, the slab may preferably be connected non-detachably to the piles, in particular formed in one piece with the piles, in particular the upper ends thereof, for example by way of joint concreting. In this way, firstly the slab can be held in position and ensure in particular reliable dissipation of loads occurring into the soil via the piles. Moreover, relative movements between the piles and the slab can be avoided.

Preferably, the piles may each comprise connection reinforcement, which preferably extends into the slab. The connection reinforcement allows the piles to be connected to the slab. Consequently, the slab can be connected to the piles.

It is in particular preferable for the connection reinforcement to be formed in a pile head. The pile head may in this case be defined as that part of a pile which, in the state of installation, protrudes from the soil. Said pile head may in particular protrude substantially vertically from the soil and/or extend orthogonally to the construction base. In particular, an upper end of a pile may form the pile head or be referred to as the pile head.

For connecting the slab to the piles, it is preferably possible for the connection reinforcement to be exposed. For this purpose, the concrete surrounding the connection reinforcement is preferably removed. The exposure may preferably occur through hydraulic cutting. Hydraulic cutting may preferably be understood as meaning that the concrete of the piles is removed, preferably at an upper end of the piles, and in this way the connection reinforcement is exposed. A part of the pile which comprises reinforced concrete is thereby shorter in terms of its length after the cutting than the pile with reinforced concrete before the cutting, preferably by a length of the pile head, which comprises the connection reinforcement. For this purpose, use may preferably be made of hydraulic pile-cutting devices and/or bearing devices with a hydraulic cutting unit. The hydraulic cutting unit may in this case preferably comprise chiseling means.

In particular, it is preferable for the connection reinforcement, in particular the exposed connection reinforcement, of the piles to be received, and integrated into the slab, during the production of the slab. For example, reinforcement of the slab may be connected to the connection reinforcement and integrate the latter. Through subsequent filling of the volume of the slab with casting material, in particular concrete, and curing of the casting material, the connection reinforcement of pile heads may be integrated into the slab and thus the slab may be connected to the piles, in particular in one piece.

It is particularly preferably possible for the piles to have reinforcement, wherein the connection reinforcement of the pile head may be in the form of structural (additional) reinforcement. Preferably, the connection reinforcement may be designed in such a way that exposure of said connection reinforcement is possible without destroying or damaging the connection reinforcement.

The connection reinforcement may preferably be in the form of longitudinal reinforcement and/or comprise longitudinal reinforcement. The longitudinal reinforcement may preferably extend in the longitudinal direction, preferably substantially parallel to the longitudinal axis of the piles.

It is in particular preferably possible for reinforcement struts, in particular struts of connection reinforcement, preferably in the case of angular piles, to preferably be formed in the corners and spaced apart from one another. In the case of round piles, the reinforcement struts, in particular struts of connection reinforcement, may preferably be formed sufficiently spaced apart from one another. The requirement of a sufficient spacing may be considered to be satisfied if exposure of the reinforcement struts, in particular by way of hydraulic cutting, is made possible without the reinforcement struts being damaged.

Alternatively, the slab may be held in position relative to the piles by way of a contact connection and/or an abutment connection. In this case, in particular due to the inherent weight of the slab and/or the weight of the slab and of the shallow foundation and/or the weight of the slab and of the shallow foundation and of the tower structure, the slab can be held in position relative to the piles.

In particular, it is preferable for priority to be given to connection reinforcement which is incorporated into the slab, in order to establish a connection between the piles and the slab.

Preferably, the piles may be arranged spaced apart from one another. In particular, a minimum distance between the piles, preferably between the pile heads, may be at least 60 cm. A maximum distance between the piles and/or between the pile heads may preferably be at most 3 m. In particular, it is preferable for a minimum distance and/or a maximum distance to be selected in a manner dependent on the expected loads which are to be dissipated to the lower soil layers via the piles. Said distance allows exposure of the connection reinforcement through hydraulic cutting to be made possible. In this way, it is possible in particular to reduce manual work steps for exposing the connection reinforcement, for example by means of an air hammer. The consequence of this is that, firstly, outlay in terms of time, cost and personnel can be reduced and, at the same time, the level of work safety can be increased.

It is particularly preferably possible for the piles to be arranged in a uniformly distributed manner and/or spaced apart uniformly from one another. In particular, the piles may also be arranged in a randomly distributed manner and/or spaced apart randomly from one another. In this case, the piles may be arranged for example in a ring-shaped manner, in particular in a ring-shaped manner below a wall of the tower structure. The piles may also be arranged distributed over the entire surface of the construction base, in particular of the slab and/or of the foundation plane, which is delimited by the dimensions of the slab. In particular, it is preferable for the piles to be arranged in a row. In this case, it is preferable for the piles to be arranged in one and/or two and/or three and/or more rows. For example, the piles may also be arranged in crossing rows and/or in rows arranged substantially parallel to one another.

Preferably, the piles may also be distributed and arranged in a manner dependent on the soil condition and/or the ambient conditions and/or the loads.

A further preferred development of the foundation is distinguished in that the slab has a connection side which is configured to be arranged on the piles, and the slab has a projection on the connection side. In particular, it is preferable for the slab to have at least two and/or at least three and/or more projections. In this case, the projection(s) may extend in the direction of the piles. In particular, it is preferable for the slab to be arranged on the piles, preferably in the sense of produced on the piles, in such a way that an end surface of the projections adjoins the piles, preferably that the end surfaces of the projections, with the upper ends of the piles, are concreted together with the slab. The end surface may preferably have dimensions which are larger than dimensions of the pile. In this case, the end surface may preferably have a larger areal extent than a cross section of a pile that is formed vertically with respect to the longitudinal axis of the pile.

Preferably, it is firstly possible for the piles to be arranged and preferably for the pile heads to be cut away. Afterwards, it is possible for example for soil to be excavated in a region so as to be able to produce in particular a formwork, preferably a permanent formwork, of the projections. The region in which the soil excavation is realized may preferably have the dimensions of the projections. It is particularly preferably possible for the projections to be cast together with the slab.

A projection may generally be understood as being an element which extends from an extent of the slab, in particular of the connection side, in the direction of the piles. Here, the projections may preferably be in the form of individual elements, in particular in the form of a beam and/or of a round elevation and/or angular elevation, for example in the form of a cuboid and/or square, or in the form of contiguous elements, in particular in the form of a grid, preferably comprising crossing beams.

Due to the configuration of the slab with projections, loads can be dissipated particularly reliably from the slab to the piles and into the soil. Furthermore, a main body of the slab may be of relatively thin form. The main body of the slab may preferably be defined as that part of the slab which has no projection. A relatively thin configuration of the main body allows material and weight to be saved. The configuration of the projections allows strengthening of the main body, that is to say preferably of the slab, at required points, in particular at points which are subjected to higher loads and/or at the points which dissipate loads absorbed by the slab to the soil via the piles.

It is basically possible for the projection(s) and the main body to be formed in one piece. Alternatively, the main body may be arranged on the projection(s). Preferably, the main body may be connected to the projection(s).

In particular, it is preferable for the slab, with projection, to have a maximum thickness of 80 cm, wherein points of the slab at which no projection is formed preferably have at least a thickness of 25 cm.

Preferably, the projection may have a maximum width of at least 50 cm to at most 80 cm, and/or a maximum thickness of approximately 55 cm. This configuration allows load distribution to be positively influenced and dissipation via the piles of the loads occurring to be promoted.

In particular, it is preferable for the slab and/or the piles and/or the shallow foundation to be in the form of a finished part or a semi-finished part and/or to comprise cast-in-place concrete or to consist of cast-in-place concrete.

According to a second aspect, the object stated in the introduction is achieved by a tower for a wind power installation that comprises a foundation.

Preferably, the tower, in particular a lower tower section, may be arranged here on the shallow foundation. In particular, the tower may be connected here to the shallow foundation. The tower, preferably a lower structure part, can be held in position by means of an abutment connection and/or a contact connection. Owing to the inherent weight of the tower, there may preferably be no need for any further connection between the tower and the shallow foundation. In this way, the erection of the tower and/or the production of the shallow foundation can be simplified. In particular, it may be preferable for the shallow foundation, in particular the standing side thereof, and/or the tower, in particular the lower structure part, to be formed from concrete or to comprise concrete. The concrete-on-concrete contact surface formed in this way has a coefficient of friction which is advantageous for stability.

The shallow foundation may preferably have stressing members or an anchoring means for anchoring stressing members therein and prestressing the tower.

In particular, it is preferable for the tower to be a steel tower and to preferably have a maximum diameter of at least 4 m, in particular preferably of up to at most 4.9 m.

Furthermore, it is preferable for the tower to be a concrete tower or a hybrid tower and to preferably have a maximum diameter of at least 6 m up to at most 13.5 m.

According to a third aspect, the object stated in the introduction is achieved by a wind power installation comprising a tower and/or a foundation.

The tower according to the second aspect and/or the wind power installation according to the third aspect and the possible developments have features that make them particularly suitable for being used for a foundation described herein and its developments and for a tower of a wind power installation and for a wind power installation. For further advantages, embodiment variants and embodiment details of these further aspects and the possible developments, reference is also made to the description with regard to the corresponding features and developments of the first aspect.

According to a further aspect, the object stated in the introduction is achieved by a method for constructing a foundation of a tower structure, in particular of a tower of a wind power installation comprising the steps of: preparing soil, setting up a soil improvement unit, comprising the steps of: arranging piles on the soil and introducing the piles into the soil, and arranging a slab on the piles, and arranging a shallow foundation on the slab.

Here, the piles are preferably introduced into the soil in such a way that a pile head of each pile protrudes from the soil. Furthermore, the piles are preferably arranged in such a way that the piles and/or the pile heads are spaced apart from one another, preferably at least 60 cm from one another.

The arrangement of the slab on the piles preferably makes possible the formation of a foundation plane, onto which the shallow foundation can be mounted.

A further preferred development of the foundation is distinguished in that preparing soil comprises: excavating soil and/or creating a flat worked surface.

In particular, it is preferable for the soil to be excavated so that the slab can be arranged below a ground top edge and/or in alignment with the ground top edge. In this case, it is particularly preferable for at least 40 cm, preferably at least 80 cm, of soil to be excavated.

A flat worked surface is generally intended to be understood as meaning a technically processed surface of the soil, in particular of a soil layer, with defined properties. Here, it is particularly preferable if, for example, the flat worked surface is of substantially horizontal form.

The flat worked surface may preferably be produced using diggers and/or bulldozers and/or graders. Furthermore, creating a flat worked surface may preferably include compacting the soil. Here, use may preferably be made of vibratory plate machines and/or rolling compactors and/or plate compactors.

The method may preferably comprise depositing a soil material. Here, it is particularly preferable if, after arranging the shallow foundation on the slab, soil material is deposited such that the shallow foundation is surrounded at least partially by the soil deposit. The depositing of the soil material may be realized in particular if the shallow foundation is arranged at least partially above the ground top edge.

A preferred development of the foundation is distinguished in that arranging the slab on the piles comprises: exposing connection reinforcement of the piles, arranging the slab on the piles, wherein the slab comprises a cutout which is provided for receiving the connection reinforcement, filling at least the cutout with casting material, and allowing the casting material to cure.

Preferably, it is also possible for the slab to be arranged on the piles as a semi-finished part, and, after being mounted onto the piles, for the semi-finished part to be filled with casting material.

Preferably, the connection reinforcement of the piles may be exposed by way of hydraulic cutting. Accordingly, piles may in this case be shortened to a required length in that the connection reinforcement is exposed.

The exposure of the connection reinforcement may preferably be realized from a construction pit boundary and/or from a ground top edge and/or from prepared soil.

Finally, it is preferable for the step of exposing to comprise cutting into the piles. Preferably, the piles may be cut as far as a prestressing steel. In this way, exposing the connection reinforcement can be simplified. Preferably, wet cutters may be used for cutting into the foundation piles.

Preferably, after exposing the connection reinforcement, a connection surface can be created through post-cutting. The connection surface is in particular to be configured in such a way that the slab can be arranged thereon or the concrete of the slab directly adjoins it, which can lead to a one-piece formation of the slab with the piles. The post-cutting may preferably be realized using an air hammer. In this way, it is in particular also possible for connection reinforcements with a high reinforcement content to be exposed.

In particular, the connection surface may be created in such a way that the slab, preferably the projections of the slab, can be mounted on the connection surface of the piles. In this case, it is advantageous in particular for the connection surface of the piles to be of horizontal and preferably areal form in the state of installation.

The method and the possible developments have features or method steps that make them particularly suitable for being used for a foundation and its developments and for a tower of a wind power installation and for a wind power installation. For further advantages, embodiment variants and embodiment details of this further aspect and the possible developments, reference is also made to the description with regard to the corresponding features and developments of the other aspects.

### BRIEF DESCRIPTION OF THE SEVERAL VIEWS OF THE DRAWINGS

Preferred exemplary embodiments will be discussed by way of example on the basis of the appended figures. In the figures:

FIG. 1 shows a three-dimensional view of a wind power installation with a foundation, with a tower and with a nacelle;

FIG. 2 shows a design drawing of a first exemplary embodiment of a foundation;

FIG. 3 shows a design drawing of a second exemplary embodiment of a foundation;

FIG. 4 shows an exemplary illustration of a soil improvement unit;

FIG. 5 shows an exemplary illustration of a pile, in particular of a pile head, with connection reinforcement;

FIG. 6 shows an exemplary illustration of a pile with exposed connection reinforcement;

FIG. 7 shows exemplary method steps for constructing a foundation of a tower structure; and

FIG. 8 shows exemplary method steps for arranging the slab on the piles.

In the figures, identical or substantially functionally identical or similar elements are denoted by the same reference signs.

### DETAILED DESCRIPTION

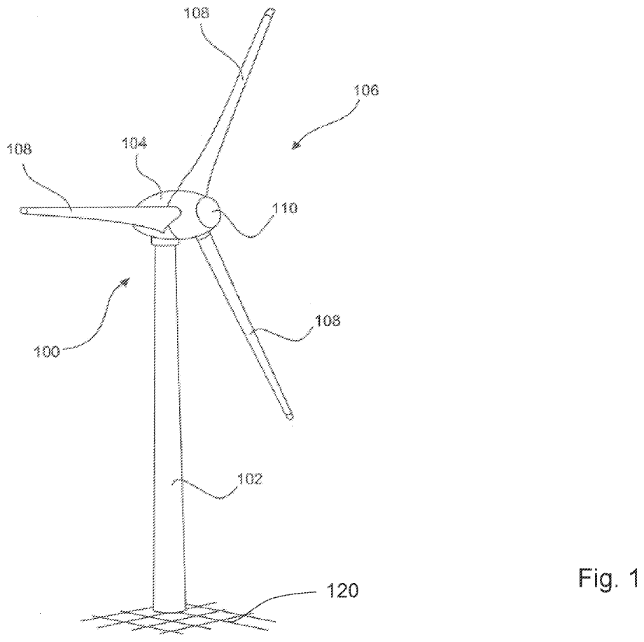

FIG. 1 shows a three-dimensional view of a wind power installation 100. The wind power installation 100 has a tower 102 and a nacelle 104 on the tower 102. An aerodynamic rotor 106 having three rotor blades 108 and having a spinner 110 is provided on the nacelle 104. During the operation of the wind power installation, the aerodynamic rotor 106 is set in rotational motion by the wind and thereby also rotates an electrodynamic rotor or runner of a generator, which is coupled directly or indirectly to the aerodynamic rotor 106. The electric generator is arranged in the nacelle 104 and generates electrical energy. The pitch angle of the rotor blades 108 can be changed by pitch motors at the rotor blade roots of the respective rotor blades 108. The tower 102 of the wind power installation 100 is erected on a foundation 120, which comprises a soil improvement unit and a shallow foundation.

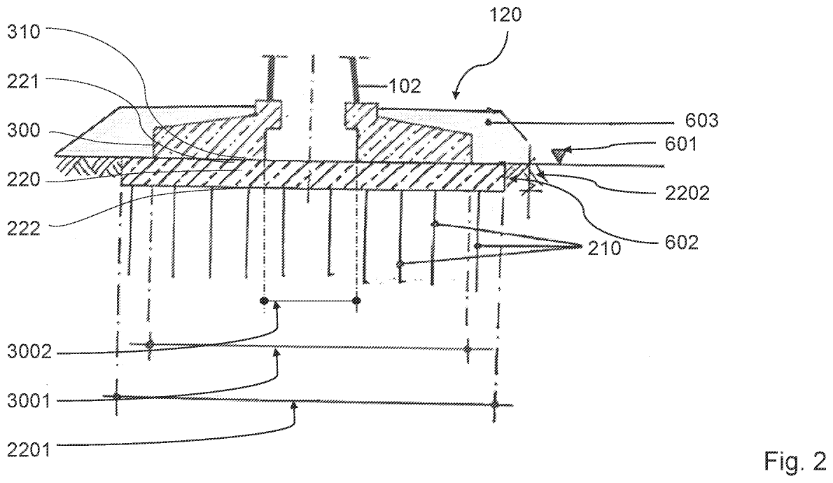

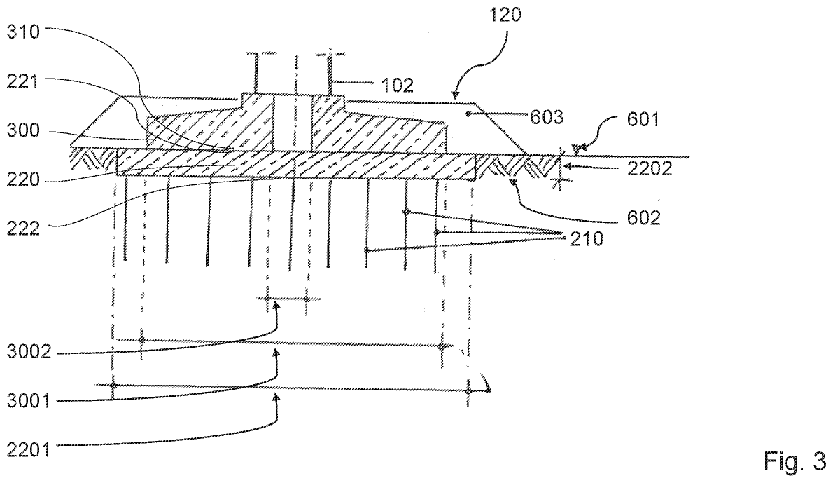

FIGS. 2 and 3 each show a foundation 120 with a soil improvement unit 200, which comprises piles 210 and a slab 220 arranged on the piles 210, and a shallow foundation 300. According to the examples shown in FIG. 2 and FIG. 3, the piles 210 are introduced into the soil 602, so that they extend into the soil 602. Here, the piles 210 are arranged spaced apart from one another. The spacing may preferably be configured to be uniform. Alternatively, it is possible for example for some of the piles 210 to be spaced apart uniformly from one another and for other piles 210 to have a larger and/or a smaller distance from adjacent piles 210. In particular, the piles 210 may be spaced apart from one another in a manner dependent on loads to be expected.

FIGS. 2 and 3 furthermore each show a slab 220, which has a connection side 222 and a foundation side 221. The connection side 222 of the slab 220 is arranged on the piles 210. The foundation side 221 is formed opposite the connection side 222 and forms the foundation plane of the slab 220. According to these exemplary embodiments, the foundation side 221 is aligned with a ground top edge 601. Alternatively, it is possible for example for the foundation side 221 to also be arranged below and/or above the ground top edge 601.

The foundation plane may preferably be of areal and/or planar form, in order for it to be possible for an areal standing side 310 of the shallow foundation 300 to be arranged thereon. The shallow foundation 300, according to the exemplary embodiments in FIGS. 1 and 2, is arranged on the foundation side 221 of the slab 220 and thus above the ground top edge 601. FIGS. 2 and 3 furthermore each show a soil deposit 603, which is deposited on the soil 602 so as to surround a large part of the shallow foundation 300. In this way, the shallow foundation can be additionally stabilized.

FIG. 2 shows an exemplary configuration of a foundation for a concrete or hybrid tower. Here, the slab 220 may preferably have a thickness 2202 of at least 40 cm to at most 80 cm. Preferably, the slab 220 may be in the form of a reinforced concrete slab. The slab 220 may preferably have a diameter 2201 of between at least 13 m and at most 30 m. Furthermore, the shallow foundation may have a maximum outer diameter 3001 preferably of between at least 12 m and at most 30 m. The maximum inner diameter 3002 may preferably be greater than 5 m.

According to this exemplary embodiment, a tower 102 for a wind power installation 100 may be in the form of a concrete or hybrid tower. In this case, the tower may preferably have a maximum diameter of between 6 m and 13.50 m. The tower 102 is arranged on the shallow foundation 300, wherein the shallow foundation 300 has a section provided for this purpose, which is not covered by the soil deposit 603.

FIG. 3 shows an exemplary configuration of a foundation for a steel tower. Here, the slab 220 may preferably have a thickness 2202 of at least 40 cm to at most 80 cm. Preferably, the slab 220 may be in the form of a reinforced concrete slab. The slab 220 may preferably have a diameter 2201 of between at least 13 m and at most 30 m. Furthermore, the shallow foundation may have a maximum outer diameter 3001 preferably of between at least 12 m and at most 30 m. The maximum inner diameter 3002 may preferably be greater than 2.20 m.

According to this exemplary embodiment, a tower 102 for a wind power installation 100 may be in the form of a steel tower. In this case, the tower may preferably have a maximum diameter of between 4 m and 4.90 m. The tower 102 is arranged on the shallow foundation 300, wherein the shallow foundation 300 has a section provided for this purpose, which is not covered by the soil deposit 603.

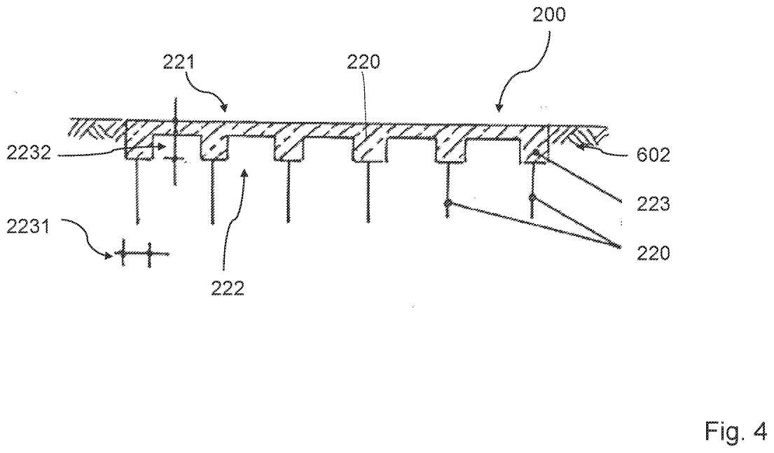

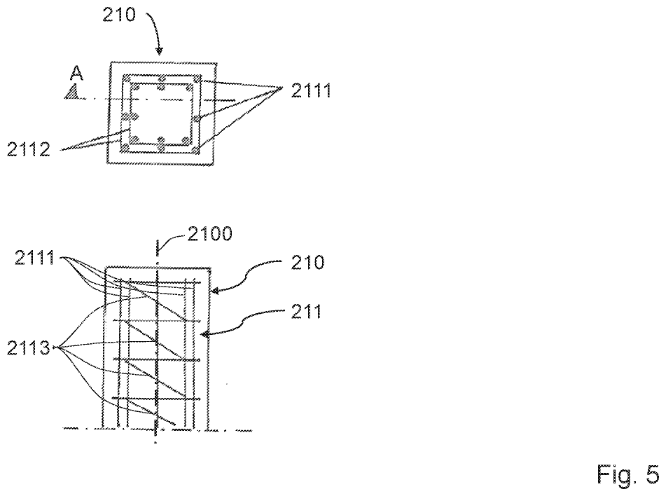

FIG. 4 shows a configuration of a soil improvement unit 200 in the state of installation in the soil 602. Here, the soil improvement unit 200 has a slab 220 with a foundation side 221 and with a connection side 222. According to this configuration, projections 223 are formed on the connection side 222 of the slab 220. The projections 223 extend in the direction of the piles 210, on which the slab 220 is arranged. In this case, the slab 220 is arranged on the piles 210 in such a way that an end surface of the projections 223 adjoins the piles 210, preferably that the end surfaces of the projections 223, with the upper ends of the piles 210, are concreted together with the slab 220. In FIG. 5, the projections have a width 2231 and a thickness 2232.

FIG. 5 shows an exemplary illustration of an arrangement of reinforcement 211 within a pile 210. For illustrative purposes, a cross section of a pile 210 that extends vertically with respect to a longitudinal axis 2100 of the pile is illustrated at the top of FIG. 5. By contrast, a cross section of a pile 210 that extends parallel to the longitudinal axis of the pile is shown at the bottom of FIG. 5. In particular, the section A in the illustration at the top of FIG. 5 is shown at the bottom of FIG. 5.

Here, the reinforcement 211 is configured as a three-dimensional strut construction comprising vertical struts 2111, horizontal struts 2112 and connecting struts 2113. In this way, the pile 210, in particular the load-bearing behavior, can be strengthened, and in particular compressive, tensile and bending forces can be absorbed.

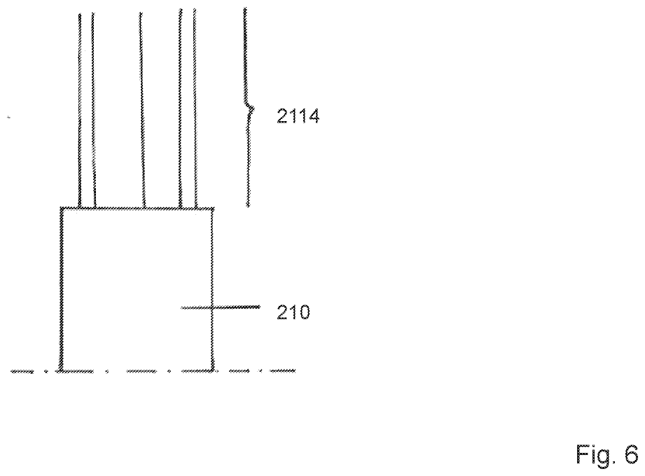

FIG. 6 illustrates a pile 210 with exposed connection reinforcement 2114. According to this exemplary embodiment, the connection reinforcement 2114 is configured as longitudinal reinforcement which extends substantially vertically. In this case, the struts of the connection reinforcement 2114 are arranged spaced apart from one another, so that exposure of said connection reinforcement 2114 is possible without the struts being damaged.

The configuration of a pile 210 with connection reinforcement 2114 allows the slab to be connected to the pile through the extension of the struts of the connection reinforcement 2114 into the slab, which is arranged on the pile 210.

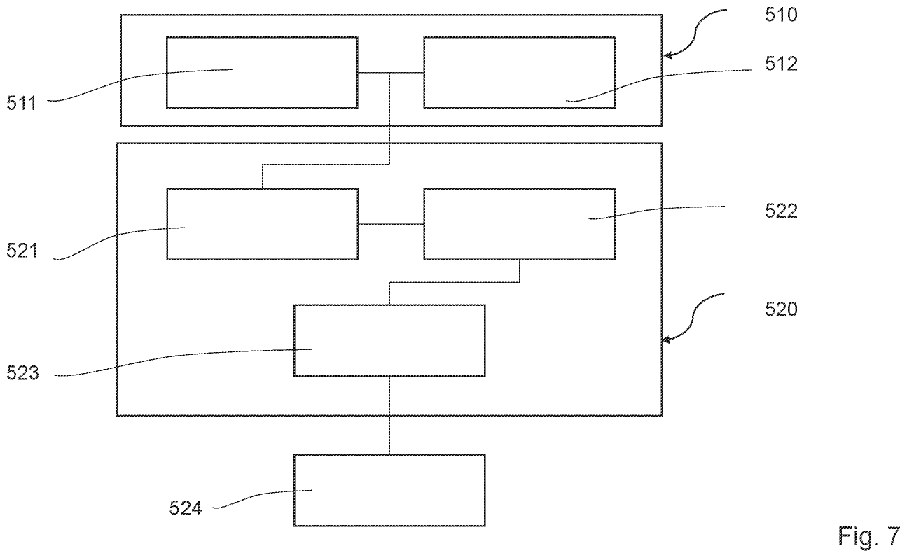

FIG. 7 furthermore illustrates exemplary method steps for constructing a foundation of a tower structure. According to the exemplary method here, firstly preparing soil 510 on which the foundation is to be erected is realized. In this case, preparing soil 510 comprises the step of excavating soil 511 and the step of creating a flat worked surface 512. Here, soil is excavated to such an extent that the foundation, in particular the soil improvement unit, can be placed in the soil excavation. After excavating soil 511, creating the flat worked surface 512 is realized. Preferably, it is consequently possible for a substantially horizontal construction base to be provided and at the same time for the soil to be compacted. In a next method step, setting up a soil improvement unit 520 is realized. In this case, setting up the soil improvement unit 520 comprises the steps of arranging piles on the soil 521, of introducing the piles into the soil 522 and of arranging a slab on the piles 523. After the soil improvement unit 25 has been erected, the method step of arranging a shallow foundation on the slab 524 follows.

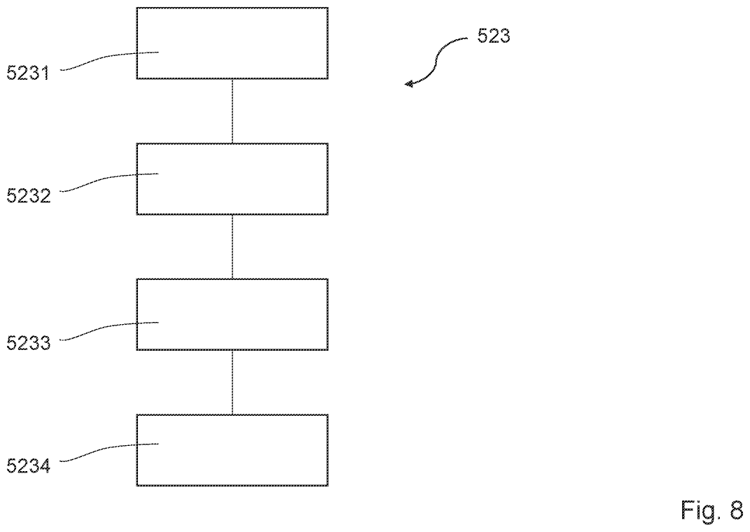

FIG. 8 illustrates, as a supplement to FIG. 7, detailed method steps for arranging the slab on the piles. Firstly, exposing connection reinforcement of the piles 5231 is realized. This can preferably occur through hydraulic cutting. Subsequently, arranging the slab on the piles 5232 may be realized, wherein the slab preferably comprises cutouts for this purpose, in order to be able to receive the exposed connection reinforcement of the piles. For connecting the slab to the piles, in particular to the connection reinforcement, filling the cutout with casting material 5233 and allowing the casting material to cure 5234 are realized.

The foundation and/or the tower structure and/or the wind power installation and/or the method for constructing a foundation have various advantages. In particular, it is consequently possible for foundations to be produced in a simple and/or cost-effective manner. Furthermore, such foundations can be used independently of soil condition and/or ambient conditions. In particular, in the case of such foundations, it is also the case that reliable dissipation into the soil of loads which occur can be ensured and, at the same time, the reliability of long-term stability of a structure can be increased.

### LIST OF REFERENCE SIGNS

100 Wind power installation
102 Tower
104 Nacelle
106 Aerodynamic rotor
108 Rotor blades
110 Spinner
120 Foundation
200 Soil improvement unit
210 Piles
211 Reinforcement
220 Slab
221 Foundation side
222 Connection side
223 Projection
300 Shallow foundation
310 Standing side
400 Connection reinforcement
510 Preparing soil
511 Excavating soil
512 Creating a flat worked surface
520 Setting up a soil improvement unit
521 Arranging piles
522 Introducing piles
523 Arranging a slab
524 Arranging a shallow foundation
601 Ground top edge
602 Soil
603 Soil deposit
2100 Longitudinal axis of a pile
2111 Vertical struts
2112 Horizontal struts
2113 Connecting struts
2114 Connection reinforcement
2201 Diameter of the slab
2202 Thickness of the slab
2231 Maximum width of the projection
2232 Maximum thickness of the projection
3001 Outer diameter of the shallow foundation
3002 Inner diameter of the shallow foundation
5231 Exposing connection reinforcement
5232 Mounting the slab
5233 Filling a cutout with casting material
5234 Allowing casting material to cure

1. A foundation for a tower of a wind power installation, the foundation comprising:
a soil improvement unit having:
a plurality of piles, and
a slab arranged on the plurality of piles and having a foundation side,
wherein the foundation side forms a foundation plane, and
a shallow foundation having an areal standing side for mounting onto the foundation plane,
wherein the shallow foundation is arranged on the slab.

2. The foundation as claimed in claim 1, wherein the shallow foundation has a maximum extent in a width direction that is greater than a maximum extent in a height direction.

3. The foundation as claimed in claim 1, wherein the slab has:
a maximum diameter of 13 meters to 31 meters, and/or
a maximum thickness of 40 centimeters to 80 centimeters.

4. The foundation as claimed in claim 1, wherein at least one of the slab, the plurality of piles, or the shallow foundation comprise reinforced concrete.

5. The foundation as claimed in claim 1, wherein the slab is connected to the plurality of piles.

6. The foundation as claimed in at least one of the claim 1, wherein each pile of the plurality of piles comprises connection reinforcement extending into the slab.

7. The foundation as claimed in claim 1, wherein the plurality of piles are arranged spaced apart from one another.

8. The foundation as claimed in claim 1 wherein:
the slab has a connection side configured to be arranged on the plurality of piles, and
the slab has a projection on the connection side.

9. The foundation as claimed in claim 8, wherein the projection has a maximum width of 50 centimeters to 80 centimeters.

10. A tower for a wind power installation, comprising the foundation as claimed in claim 1.

11. A wind power installation, comprising a tower and the foundation as claimed in claim 1.

12. A method for constructing a foundation of a tower of a wind power installation, the method comprising:
preparing soil,
setting up a soil improvement unit, wherein the setting up comprises:
arranging a plurality of piles on the soil and introducing the plurality of piles into the soil, and
arranging a slab on the plurality of piles, and
arranging a shallow foundation on the slab.

13. The method as claimed in claim 12, wherein preparing soil comprises at least one of:
excavating soil, and/or
creating a flat surface.

14. The method as claimed in claim 12, wherein arranging the slab on the plurality of piles comprises:
exposing connection reinforcement of the plurality of piles,
arranging the slab on the plurality of piles, wherein the slab comprises a cutout configured to receive the connection reinforcement,
filling the cutout with casting material, and
allowing the casting material to cure.

15. The method as claimed in claim 14, wherein the exposing the connection reinforcement comprises cutting into the plurality of piles.

16. The foundation as claimed in claim 8, wherein the projection has a maximum thickness of approximately 55 centimeters.
